(19) United States
(12) Patent Application Publication
(10) Pub. No.: US 2024/0340404 A1
(43) Pub. Date: Oct. 10, 2024

(54) FOURIER TRANSFORM PROFILOMETRY WITH A DUAL READOUT SENSOR

(71) Applicant: Meta Platforms Technologies, LLC, Menlo Park, CA (US)

(72) Inventors: Song CHEN, Redmond, WA (US); Qing Chao, Redmond, WA (US); Yi Zheng, Redmond, WA (US)

(73) Assignee: Meta Platforms Technologies, LLC, Menlo Park, CA (US)

(21) Appl. No.: 18/130,593

(22) Filed: Apr. 4, 2023

(51) Int. Cl. H04N 13/383; G02B 27/01; G06F 1/16; H04N 13/128; H04N 13/207; H04N 13/344

(52) U.S. Cl. CPC H04N 13/383; G02B 27/0172; G02B 27/0179; G06F 1/163; H04N 13/128; H04N 13/207; H04N 13/344; G02B 2027/0178; G02B 2027/0187; H04N 2013/0081

(57) ABSTRACT

A system for three-dimensional object sensing using fringe-projection profilometry with Fourier transform analysis is described. A fringe-projection profilometry (FPP) projector simultaneously transmits a frequency signal pattern (i.e., modulated or AC signal) and a zero-frequency signal pattern (i.e., unmodulated or DC signal) onto an object's surface. Alternatively, the projector projects two frequency signal patterns phase-shifted by 180 degrees. A dual readout sensor captures reflections of both signals from the object's surface as adjacent frames, and the DC signal is extracted by subtraction of addition to obtain an enhanced signal. The enhanced signal is used to generate a wrapped phase map through Fourier transform profilometry (FTP). The resulting wrapped phase map is unwrapped, and three-dimensional reconstruction of the object's surface is generated by converting phase from the unwrapped phase map to three-dimensional coordinates.

### TECHNICAL FIELD

This patent application relates generally to three-dimensional sensing, and in particular, three-dimensional reconstruction through fringe-projection based Fourier transform profilometry.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment. Head-mounted display (HMD) devices may also present interactive content, where a user's (wearer's) gaze may be used as input for the interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display device, according to an example.

FIGS. 2A-2C illustrate various views of a near-eye display device in the form of a head-mounted display (HMD) device, according to examples.

FIGS. 3A and 3B illustrate a perspective view and a top view of a near-eye display device in the form of a pair of glasses, according to an example.

FIGS. 4A-4B illustrate a fringe-projection based Fourier transform profilometry system for three-dimensional reconstruction, according to examples.

FIG. 5 illustrates a diagram of a dual readout global shutter sensor, according to an example.

FIGS. 6A-6B illustrate synchronization charts for DC subtraction and DC cancellation techniques, according to examples.

FIGS. 7A-7B illustrate workflow charts for DC subtraction and DC cancellation techniques, according to examples.

FIGS. 8A-8B illustrate flow diagrams for methods of generating three-dimensional reconstructions through DC subtraction and DC cancellation Fourier transform profilometry, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Tracking a position and orientation of the eye as well as gaze direction in head-mounted display (HMD) devices may unlock display and rendering architectures that can substantially alleviate the power and computational requirements to render 3D environments. Furthermore, eye-tracking enabled gaze prediction and intent inference can enable intuitive and immersive user experiences adaptive to the user requirements in his/her interaction with the virtual environment.

Eye tracking may be achieved via a number of techniques. Fringe projection, which projects a periodical pattern onto the eye and uses the reflected pattern to determine 3D features, is one technique. Fringe patterns are periodical patterns. When a phase of the pattern is constrained to a particular interval, the phase of the fringe pattern is called a wrapped phase. Otherwise, the phase is called an unwrapped phase. To determine depth information and remove discontinuities, the phase of the captured fringe pattern may be unwrapped. One of the techniques for generating an unwrapped phase map is spatial phase unwrapping. Thus, eye tracking is a sub category of three-dimensional object sensing. In some three-dimensional object sensing (e.g., eye tracking, face tracking, speed tracking) systems, fringe projection profilometry (FPP) may be used. Such systems may include a fringe projector and one or multiple cameras. One or a series of fringe patterns may be projected onto a scene that includes the object, and the camera(s) may capture the scene at the same time. By analyzing the distorted fringe pattern, the three-dimensional geometry of the scene may be reconstructed.

To achieve high frame rate, Fourier transform-based fringe analysis may be used, since this technique only requires one frame for each three-dimensional reconstruction. However, Fourier transform profilometry (FTP) presumes spatial intensity distribution of the fringe pattern to be uniform. This presumption may not necessarily be valid for a variety of fringe projectors. Especially for low-cost fringe projectors, the evenness of the intensity distribution may not be guaranteed. Furthermore, Fourier transform profilometry (FTP) may also presume reflectance of the scene is uniform so that the perceived direct component (DC) in the fringe signal is uniform. This presumption may also be not true. For example, on a human face, the reflectances of the lip and the eyebrow are typically different.

The present disclosure describes a system for three-dimensional object sensing using fringe-projection profilometry with Fourier transform analysis. In some examples, a fringe-projection profilometry (FPP) projector may simultaneously (or consecutively) transmit a frequency signal pattern (i.e., modulated or AC signal) and a zero-frequency signal pattern (i.e., unmodulated or DC signal) onto an object's surface. A dual readout sensor may capture reflections of both signals from the object's surface, and the DC signal may be subtracted from the AC signal before further processing. In other examples, the fringe-projection profilometry (FPP) projector may simultaneously (or consecutively) transmit two periodic phase-shifted frequency signal patterns onto the object's surface. The two phase-shifted frequency signal patterns may be phase-shifted by 180 degrees. The dual readout sensor may capture reflections of both phase-shifted frequency signal patterns, and a DC signal cancellation may be performed by adding the two phase-shifted frequency signal patterns. In both examples, the derived signal may be used to generate a wrapped phase map through Fourier transform profilometry (FTP). The resulting wrapped phase map may be unwrapped, for example, using a depth-calibrated unwrapped phase map. A three-dimensional reconstruction of the object's surface may be generated by converting phase from the unwrapped phase map to three-dimensional coordinates.

While some advantages and benefits of the present disclosure are apparent, other advantages and benefits may include increased accuracy and increased speed of three-dimensional object sensing such as in eye tracking without added complexity to the eye tracking system.

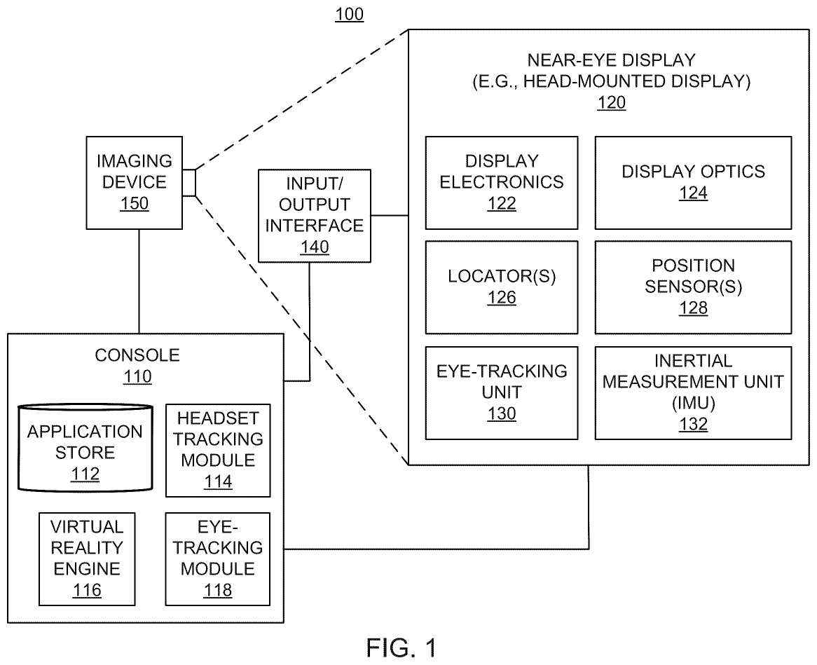

FIG. 1 illustrates a block diagram of an artificial reality system environment 100 including a near-eye display device, according to an example. As used herein, a “near-eye display device” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display device.”

As shown in FIG. 1, the artificial reality system environment 100 may include a near-eye display device 120, an optional external imaging device 150, and an optional input/output interface 140, each of which may be coupled to a console 110. The console 110 may be optional in some instances as the functions of the console 110 may be integrated into the near-eye display device 120. In some examples, the near-eye display device 120 may be a head-mounted display (HMD) that presents content to a user.

In some instances, for a near-eye display device, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display device, light from a surrounding environment may traverse a “see-through” region of a waveguide display (e.g., a transparent substrate) to reach a user's eyes. For example, in a near-eye display device, light of projected images may be coupled into a transparent substrate of a waveguide, propagate within the waveguide, and be coupled or directed out of the waveguide at one or more locations to replicate exit pupils and expand the eye box.

In some examples, the near-eye display device 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

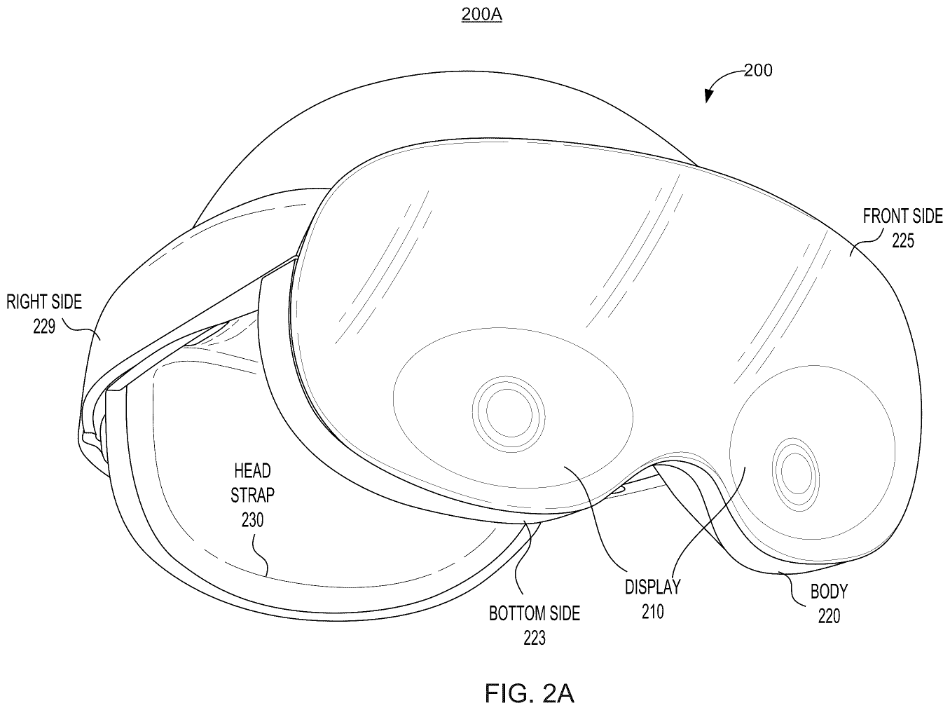

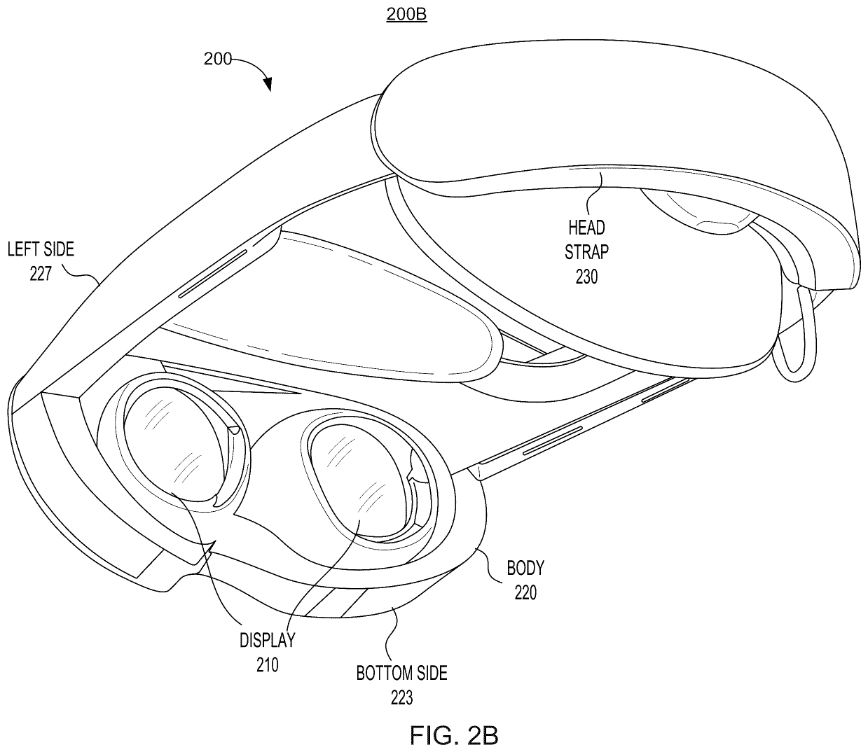

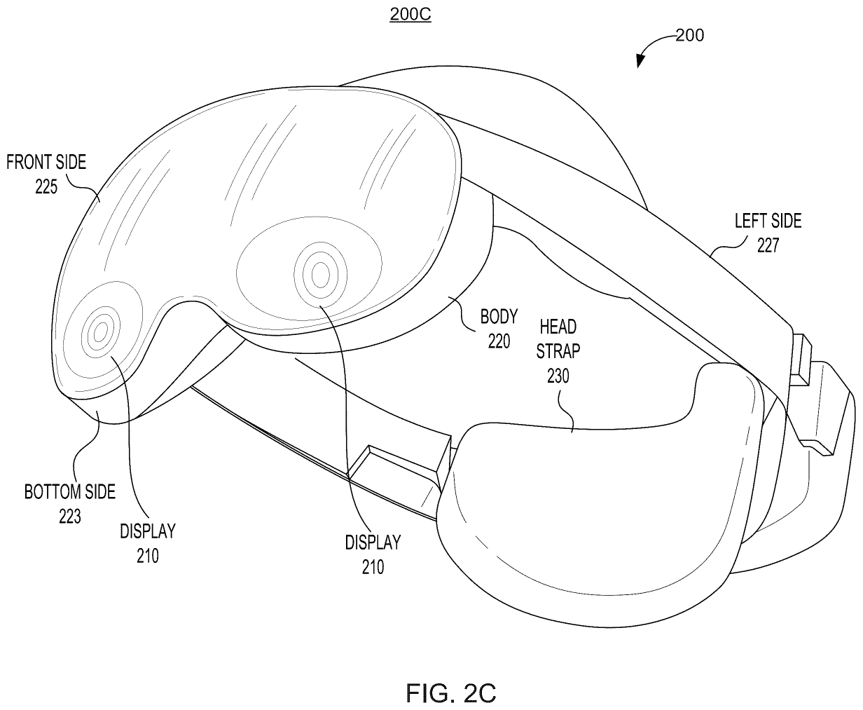

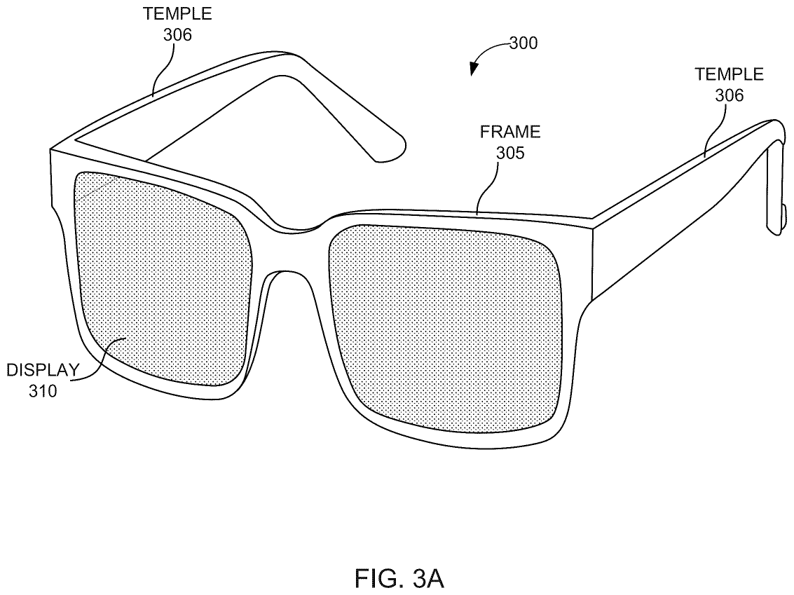

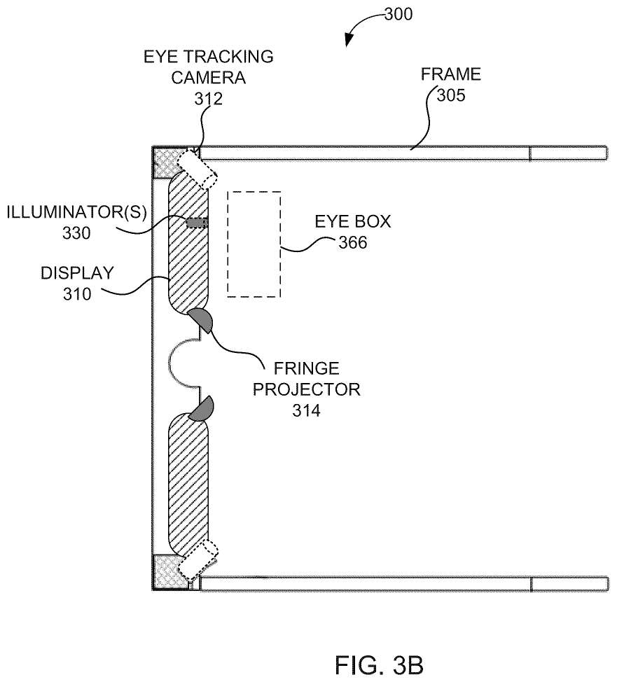

In some examples, the near-eye display device 120 may be implemented in any suitable form-factor, including a head-mounted display (HMD), a pair of glasses, or other similar wearable eyewear or device. Examples of the near-eye display device 120 are further described below with respect to FIGS. 2 and 3. Additionally, in some examples, the functionality described herein may be used in a head-mounted display (HMD) or headset that may combine images of an environment external to the near-eye display device 120 and artificial reality content (e.g., computer-generated images). Therefore, in some examples, the near-eye display device 120 may augment images of a physical, real-world environment external to the near-eye display device 120 with generated and/or overlaid digital content (e.g., images, video, sound, etc.) to present an augmented reality to a user.

In some examples, the near-eye display device 120 may include any number of display electronics 122, display optics 124, and an eye tracking unit 130. In some examples, the near-eye display device 120 may also include one or more locators 126, one or more position sensors 128, and an inertial measurement unit (IMU) 132. In some examples, the near-eye display device 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display device 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display device 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display device 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display device 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display device 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display device 120 that may be relative to an initial position of the near-eye display device 120. For example, the inertial measurement unit (IMU) 132 may integrate measurement signals received from accelerometers over time to estimate a velocity vector and integrate the velocity vector over time to determine an estimated position of a reference point on the near-eye display device 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera). In other examples, the eye tracking unit 130 may capture reflected radio waves emitted by a miniature radar unit. These data associated with the eye may be used to determine or predict eye position, orientation, movement, location, and/or gaze.

In some examples, the near-eye display device 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display device 120 for presentation to the user in accordance with information received from one or more of external imaging device 150, the near-eye display device 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display device 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display device 120 using slow calibration information from the external imaging device 150. For example, the headset tracking module 114 may determine positions of a reference point of the near-eye display device 120 using observed locators from the slow calibration information and a model of the near-eye display device 120. Additionally, in some examples, the headset tracking module 114 may use portions of the fast calibration information, the slow calibration information, or any combination thereof, to predict a future location of the near-eye display device 120. In some examples, the headset tracking module 114 may provide the estimated or predicted future position of the near-eye display device 120 to the virtual reality engine 116.

In some examples, the virtual reality engine 116 may execute applications within the artificial reality system environment 100 and receive position information of the near-eye display device 120, acceleration information of the near-eye display device 120, velocity information of the near-eye display device 120, predicted future positions of the near-eye display device 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display device 120 for presentation to the user.

In some examples, the eye tracking module 118, which may be implemented as a processor, may receive eye tracking data from the eye tracking unit 130 and determine the position of the user's eye based on the eye tracking data. In some examples, the position of the eye may include an eye's orientation, location, or both relative to the near-eye display device 120 or any element thereof. So, in these examples, because the eye's axes of rotation change as a function of the eye's location in its socket, determining the eye's location in its socket may allow the eye tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

In some examples, a sensor of the near-eye display device 120 may include a dual readout sensor. A fringe-projection profilometry (FPP) projector may transmit a frequency signal pattern and a zero-frequency signal pattern onto an object's (e.g., eye in case of eye tracking) surface. The fringe-projection profilometry (FPP) projector may also transmit two periodic phase-shifted frequency signal patterns onto the object's surface, where the two phase-shifted frequency signal patterns may be phase-shifted by 180 degrees. The dual readout sensor may capture reflections of both transmitted patterns (frequency and zero frequency or phase-shifted frequency signal patterns), and a direct component (DC) signal may be removed through subtraction or cancellation. In both examples, the derived signal may be used to generate a wrapped phase map through Fourier transform profilometry (FTP). The resulting wrapped phase map may be unwrapped, for example, using a depth-calibrated unwrapped phase map. A three-dimensional reconstruction of the object's surface may be generated by converting phase from the unwrapped phase map to three-dimensional coordinates.

FIGS. 2A-2C illustrate various views of a near-eye display device in the form of a head-mounted display (HMD) device 200, according to examples. In some examples, the head-mounted device (HMD) device 200 may be a part of a virtual reality (VR) system, an augmented reality (AR) system, a mixed reality (MR) system, another system that uses displays or wearables, or any combination thereof. As shown in diagram 200A of FIG. 2A, the head-mounted display (HMD) device 200 may include a body 220 and a head strap 230. The front perspective view of the head-mounted display (HMD) device 200 further shows a bottom side 223, a front side 225, and a right side 229 of the body 220. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components such as a display 210 to present a wearer augmented reality (AR)/virtual reality (VR) content and a camera to capture images or videos of the wearer's environment.

As shown in the bottom perspective view of diagram 200B of FIG. 2B, the display 210 may include one or more display assemblies and present, to a user (wearer), media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the user may interact with the presented images or videos through eye tracking sensors enclosed in the body 220 of the head-mounted display (HMD) device 200. The eye tracking sensors may also be used to adjust and improve quality of the presented content.

In some examples, the head-mounted display (HMD) device 200 may include a fringe-projection profilometry (FPP) projector and the camera or the eye tracking sensors may include a dual readout sensor. The projector may transmit a frequency signal pattern and a zero-frequency signal pattern onto an object's (e.g., eye in case of eye tracking) surface. The projector may also transmit two periodic phase-shifted frequency signal patterns onto the object's surface, where the two phase-shifted frequency signal patterns may be phase-shifted by 180 degrees. The dual readout sensor may capture reflections of both transmitted patterns (frequency and zero frequency or phase-shifted frequency signal patterns), and a direct component (DC) signal may be removed through subtraction or cancellation. In both examples, the derived signal may be used to generate a wrapped phase map through Fourier transform profilometry (FTP). The resulting wrapped phase map may be unwrapped, for example, using a depth-calibrated unwrapped phase map. A three-dimensional reconstruction of the object's surface may be generated by converting phase from the unwrapped phase map to three-dimensional coordinates.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface for communicating with a console communicatively coupled to the head-mounted display (HMD) device 200 through wired or wireless means. In some examples, the head-mounted display (HMD) device 200 may include a virtual reality engine (not shown) that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine may be used for producing a signal (e.g., display instructions) to the display 210. In some examples, the head-mounted display (HMD) device 200 may include locators (not shown), which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

FIG. 3A is a perspective view of a near-eye display device 300 in the form of a pair of glasses (or other similar eyewear), according to an example. In some examples, the near-eye display device 300 may be a specific example of near-eye display device 120 of FIG. 1 and may be configured to operate as a virtual reality display, an augmented reality (AR) display, and/or a mixed reality (MR) display.

In some examples, the near-eye display device 300 may include a frame 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display device 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 210 may include a projector, or in place of the display 310 the near-eye display device 300 may include a projector.

In some examples, the near-eye display device 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display device, and/or to provide an interactive virtual reality (VR), augmented reality (AR), and/or mixed reality (MR) experience to a user of the near-eye display device 300. In some examples, the various sensors may also be used for stereoscopic imaging or other similar applications.

In some examples, the near-eye display device 300 may further include one or more illuminators to project light into a physical environment. The projected light may be associated with different frequency bands (e.g., visible light, infra-red light, ultra-violet light, etc.), and may serve various purposes. In some examples, the one or more illuminator(s) may be used as locators, such as the one or more locators 126 described above with respect to FIGS. 1-2.

In some examples, the near-eye display device 300 may also include a camera or other image capture unit. The camera, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications. The near-eye display device 300 may also include an eye tracking camera.

FIG. 3B is a top view of a near-eye display device 300 in the form of a pair of glasses (or other similar eyewear), according to an example. In some examples, the near-eye display device 300 may include a frame 305 having a form factor of a pair of eyeglasses. The frame 305 supports, for each eye: a fringe projector 314 such as any fringe projector variant considered herein, a display 310 to present content to an eye box 366, an eye tracking camera 312, and one or more illuminators 330. The illuminators 330 may be used for illuminating an eye box 366, as well as, for providing glint illumination to the eye. The fringe projector 314 may provide a periodic fringe pattern onto a user's eye. The display 310 may include a pupil-replicating waveguide to receive the fan of light beams and provide multiple laterally offset parallel copies of each beam of the fan of light beams, thereby extending a projected image over the eye box 366.

In some examples, the pupil-replicating waveguide may be transparent or translucent to enable the user to view the outside world together with the images projected into each eye and superimposed with the outside world view. The images projected into each eye may include objects disposed with a simulated parallax, so as to appear immersed into the real-world view.

The eye tracking camera 312 may be used to determine position and/or orientation of both eyes of the user. Once the position and orientation of the user's eyes are known, a gaze convergence distance and direction may be determined. The imagery displayed by the display 310 may be adjusted dynamically to account for the user's gaze, for a better fidelity of immersion of the user into the displayed augmented reality scenery, and/or to provide specific functions of interaction with the augmented reality. In operation, the illuminators 330 may illuminate the eyes at the corresponding eye boxes 366, to enable the eye tracking cameras to obtain the images of the eyes, as well as to provide reference reflections. The reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes 366.

In some examples, the image processing and eye position/orientation determination functions may be performed by a central controller, not shown, of the near-eye display device 300. The central controller may also provide control signals to the display 310 to generate the images to be displayed to the user, depending on the determined eye positions, eye orientations, gaze directions, eyes vergence, etc.

The near-eye display device 300 in FIG. 3A is an example of outward (environment sensing) or inward (eye tracking) fringe-projection profilometry (FPP) application. For example, one of the illuminator(s) 330 may be a fringe-projection profilometry (FPP) projector and the camera 340 may include the dual readout sensor. In the eye tracking example, the fringe projector 314 may be the fringe-projection profilometry (FPP) projector and the eye tracking camera 312 may include a dual readout sensor.

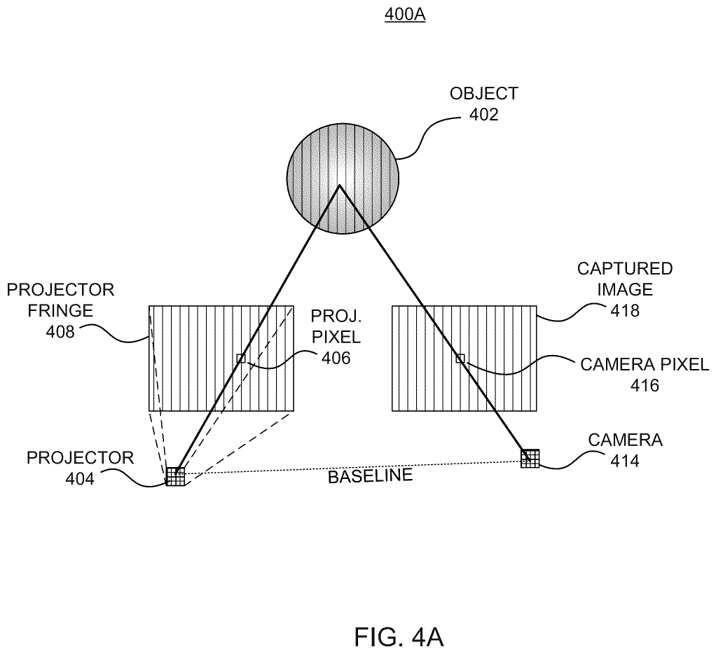

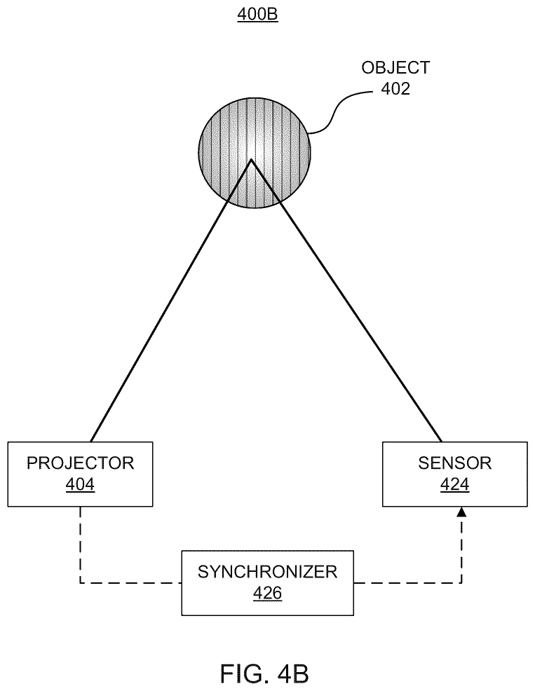

FIGS. 4A-4B illustrate a fringe-projection based Fourier transform profilometry system for three-dimensional reconstruction, according to examples. Diagram 400A shows a three-dimensional object 402, a projector 404, a projector fringe (pattern) 408, a captured image 418, and a camera 414 to capture the image 418. The object 402 may be, for example, any object in an environment (environment sensing) of a user, a face (face tracking), or an eye (eye tracking). The projector 404 may transmit projector fringe 408 onto the object 402 and some or all pixels (e.g., projected pixel 406) may be reflected from the object with distortion as camera pixel 416 in the captured image 418. Through a baseline comparison, the reflected image may be analyzed to generate a three-dimensional reconstruction of the object (i.e., its depth features).

Eye, face, or other object sensing (e.g., for tracking) may be achieved via a number of techniques. One such technique, fringe-projection profilometry (FPP) is based on structured illumination for optical three-dimensional (3D) shape (i.e., the object 402) measurement. Fringe-projection profilometry (FPP) may provide a 3D topography of the object in a non-contact manner, with high resolution, and fast data processing.

Fringe patterns are periodical patterns. When a phase of the pattern, φ(t), is constrained to its principal value, (e.g., in the interval (−π, π590619 or [0, 2π)), the phase of the fringe pattern is called a wrapped phase. Otherwise, the phase is called an unwrapped phase, which is a continuous function of time (t). Phase unwrapping is important in fringe pattern based object sensing because only wrapped phase ranging from −π to +π is obtained through analyzing fringe pattern employing a phase-shifting technique, a Fourier transform technique, or a wavelet transform technique, and discontinuities in the phase map generated from fringe images need to be removed. To unwrap the phase and determine depth information, 2π discontinuous locations may be identified and removed by adding or subtracting multiple integer numbers of 2π.

One fringe projection profilometry (FPP) approach is adaptive projection, which relies on fringe patterns with spatial pitch variation to achieve improved accuracy and coverage for an object being measured. However, modifying the projection pattern may add to complexity and processing time. Another approach is temporal phase unwrapping may obtain an absolute phase map in the sense that the unwrapped phase map has a deterministic correspondence relationship with the camera. Yet, temporal phase unwrapping techniques usually require additional patterns, which may slow the measurement speed and may not be suitable for dynamic scenes.

Spatial phase unwrapping techniques have the advantage of higher speed because additional patterns are not needed. Some spatial phase unwrapping techniques may set an arbitrary starting point and then detect the discontinuities by analyzing the neighboring pixels to generate a relative unwrapped phase map, where the unwrapped phase map is relative to the arbitrary starting point. However, the relative phase map may have an overall shift from the absolute unwrapped phase map, which may cause the reconstructed 3D shape to be distorted.

In some examples, a dual readout sensor 424 and a synchronizer 426 may be used together with the projector 404 as shown in diagram 400B of FIG. 4B to overcome the shortcomings of Fourier transform profilometry (FTP) while maintaining low cost. In the dual readout sensor 424, one channel may capture the fringe image like a normal sensor, whereas the other channel may perceive the direct component (DC) information. By subtracting the direct component (DC) signal from the fringe image, an accurate fringe signal consistent with the assumption in Fourier transform profilometry (FTP) may be obtained.

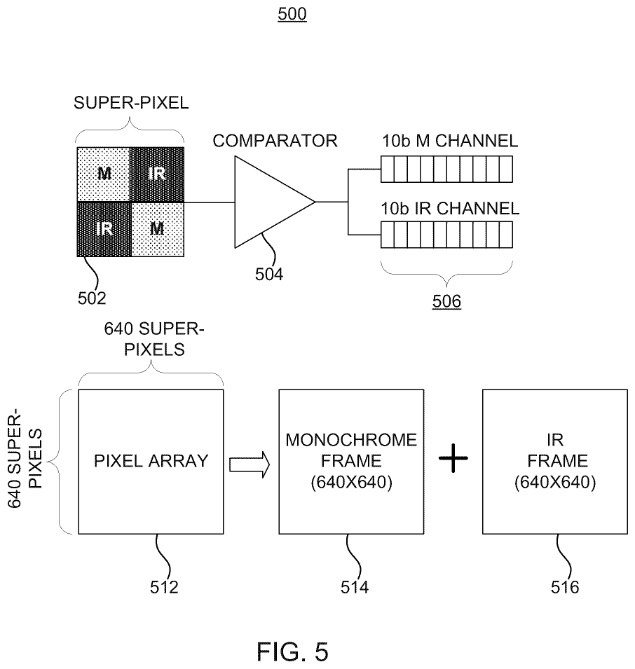

FIG. 5 illustrates a diagram of a dual readout global shutter sensor, according to an example. Diagram 500 shows how in an example dual readout sensor a super-pixel 502 with two monochrome pixels and two infrared (IR) pixels is passed through a comparator 504 and the pixel information provided to respective 10-bit buffers as monochrome and infrared (IR) channels 506 (e.g., SRAM). Thus, a monochrome frame 514 of 640 by 640 pixels and an infrared (IR) frame 526 of 640 by 640 pixels may be extracted from a pixel array 512 of 640 by 640 super-pixels. With a dual-readout global shutter feature, two adjacent frames may be captured and read out quickly, whereas a traditional single readout sensor needs longer time to process the data for two adjacent frames.

Conventional fringe-projection profilometry (FPP) sensors assume that the reflectance of a scene is uniform. However, the DC component that is contained within the fringe signals may not always be uniform. In some examples, sensor readouts may be enhanced by subtracting or canceling the DC signal components from the AC signal components that are reflected by the scanned object. Additionally, the dual readout global shutter sensor may capture two adjacent frames faster when compared to traditional single readout sensors, which require longer times to process the same data.

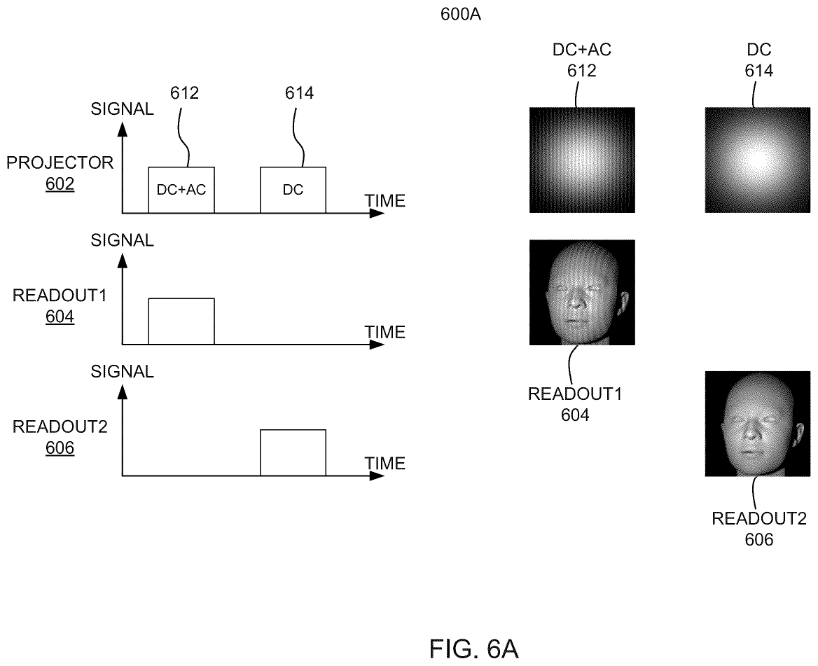

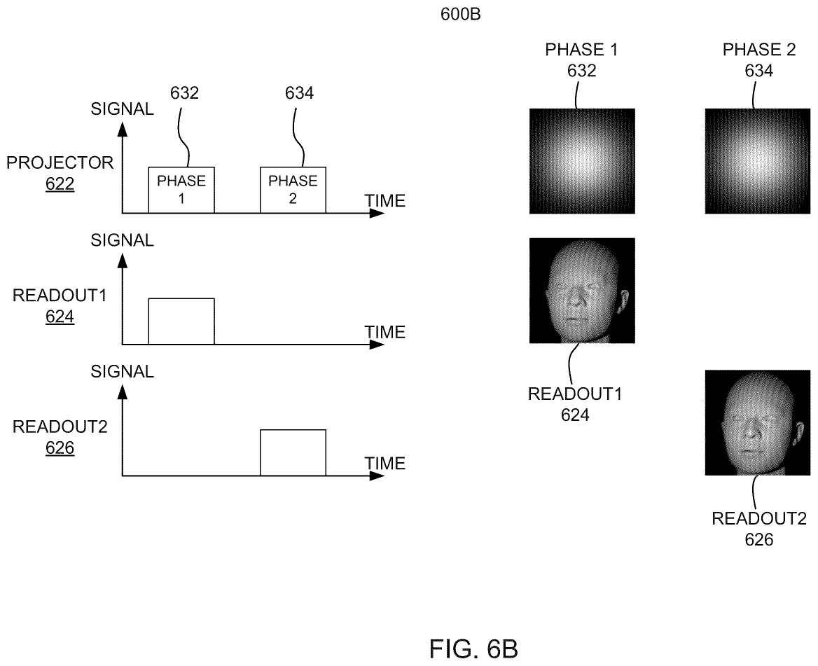

FIGS. 6A-6B illustrate synchronization charts for DC subtraction and DC cancellation techniques, according to examples. Diagram 600A shows a projector output 602 that includes two transmitted patterns, a DC+AC pattern signal 612 and a DC only pattern signal 614. The diagram also shows a first sensor readout 604 and a second sensor readout 606 along with images of each of the components and readouts.

In diagram 600B of FIG. 6B, a projector output 622 includes two phase-shifted frequency signal patterns 632 and 634 that are phase-shifted by 180 degrees. The corresponding sensor readouts 624 and 626 include two adjacent frames of captured reflections of the projected patterns from a target object (e.g., face, eye, or any object in the user's environment).

With multiple fringe images, a noise in the phase computation may be suppressed using the least-square method, for example. However, capturing multiple frames reduces the three-dimensional frame rate. Thus, in phase-shifting profilometry (PSP), for example, four steps of phase-shifting patterns may be needed for accuracy. Therefore, assuming a two-dimensional frame rate of 120 Hz for the projector and camera, the three-dimensional frame rate is reduced to 120/4=30 Hz.

In some examples, a fringe-projection profilometry (FPP) synchronizer may manage the projector and the sensor allowing enhancement of sensor output signal by cancelling the DC component through subtraction of sensor readouts of adjacent frames (AC+DC frame and DC frame or the two phase-shifted patterns). The enhanced signal may then be processed using Fourier transform profilometry (FTP) to three-dimensionally reconstruct the sensed object.

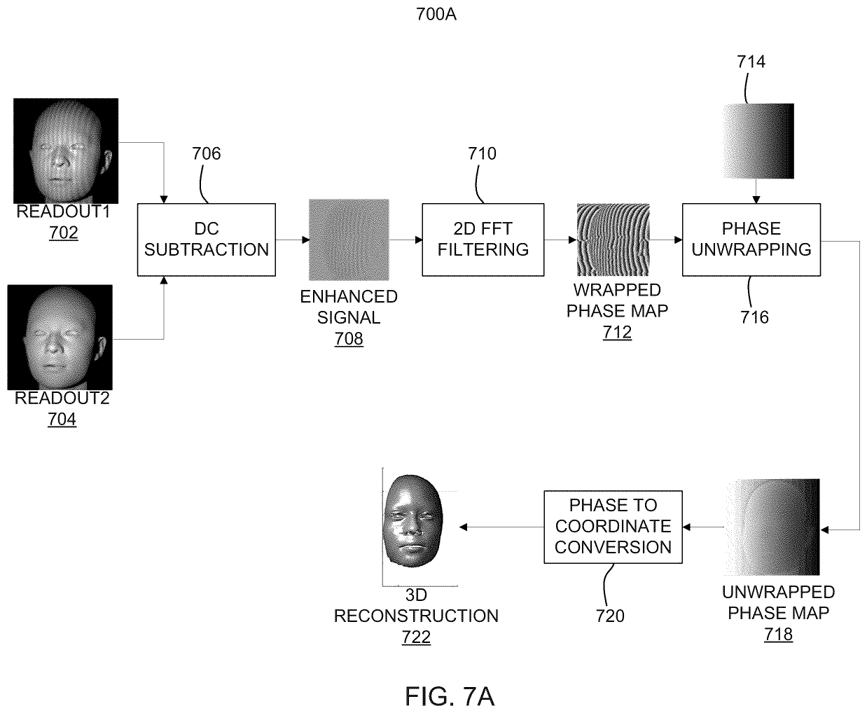

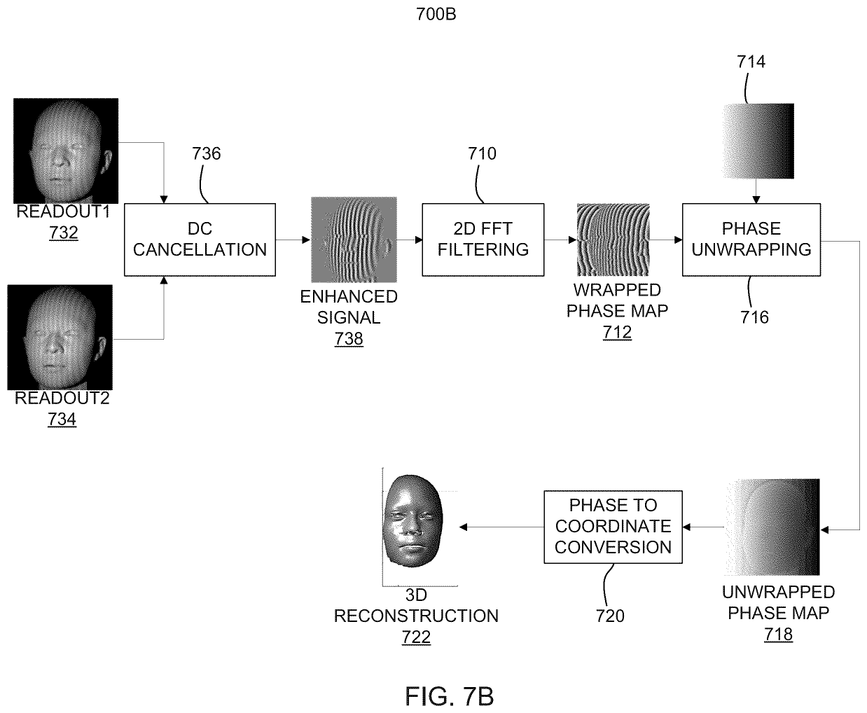

FIGS. 7A-7B illustrate workflow charts for DC subtraction and DC cancellation techniques, according to examples. Diagrams 700A and 700B show similar processes for two different pattern projections. In the diagram 700A, a readout 702 with AC+DC components (modulation and no modulation) and a readout 704 with DC component only (no modulation) are captured as two adjacent frames. The DC component is removed by subtracting (706) one from the other resulting in an enhanced signal 708 that has substantially less noise. The enhanced signal is then subjected to two-dimensional Fast Fourier Transform (FFT) filtering 710 providing a wrapped phase map 712 for the target object.

In some examples, the wrapped phase map 712 may be unwrapped through phase unwrapping 716 using a depth-calibrated unwrapped phase map 714 or other techniques. The unwrapped phase map 718 may be used to convert phase values to coordinates (720), which are used to perform a three-dimensional reconstruction 722 of the object. With three-dimensional features (i.e., depth values) of the object on hand, tracking such as eye, face, or speed tracking may be performed accurately and without a slow process dues to capture of multiple frames serially.

Diagram 700B shows a similar process with a different initial portion. In the process of the diagram 700B, a first readout 732 and a second readout 734 (two adjacent frame captures) may include 180-degree phase-shifted pattern reflections from the object. The readouts may be used to obtain an enhanced signal 738 by DC cancellation 736 (e.g., adding the phase-shifted pattern signals together).

Simulations of various techniques may show that the dual readout Fourier Transform Profilometry (FTP) provides considerably higher accuracy compared to single readout approach. The accuracy may be similar to a 3-step phase-shifting technique, but at 3 times or higher increased processing speed. Thus, high speed, high accuracy object sensing may be achieved without adding complexity to a system. Example systems may be implemented with a variety of projectors such as a digital fringe projector, an interferometry-based fringe projector, a shadow mask-based fringe projector, etc., as long as the projector is capable of providing DC projection or fringe patterns with inverted phases.

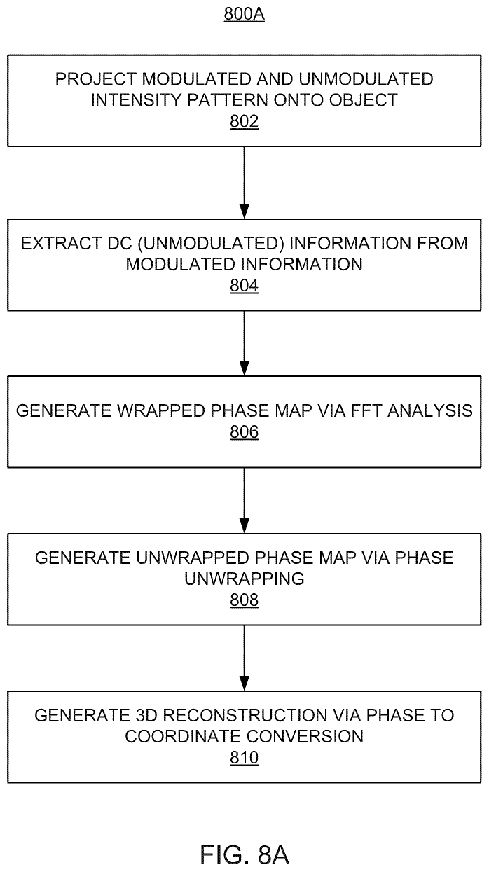

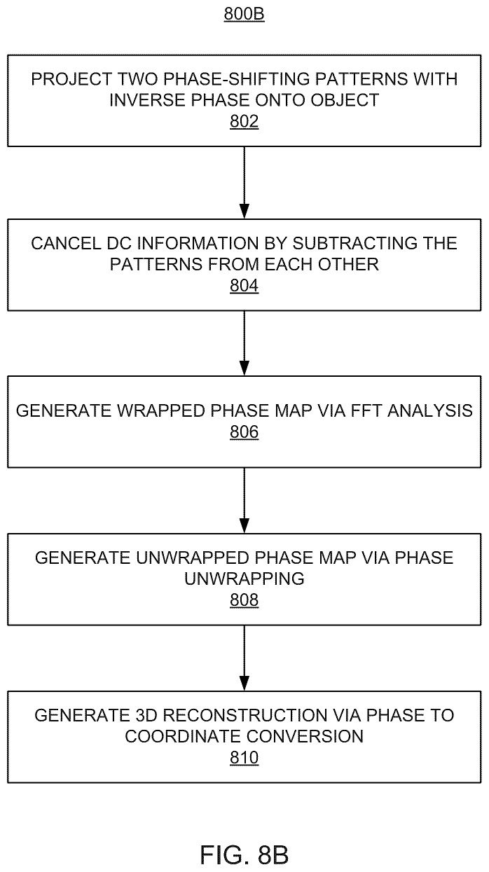

FIGS. 8A-8B illustrate flow diagrams for methods of generating three-dimensional reconstructions through DC subtraction and DC cancellation Fourier transform profilometry, according to some examples.

The methods 800A and 800B are provided by way of example, as there may be a variety of ways to carry out the method described herein. Although the methods 800A and 800B are primarily described as being performed by the components of FIGS. 4A, 4B, and 5, the methods 800A and 800B may be executed or otherwise performed by one or more processing components of another system or a combination of systems. Each block shown in FIGS. 8A and 8B may further represent one or more processes, methods, or subroutines, and one or more of the blocks may include machine readable instructions stored on a non-transitory computer readable medium and executed by a processor or other type of processing circuit to perform one or more operations described herein.

At block 802 of FIG. 8A, a fringe pattern (modulated signal containing AC and DC) and an unmodulated signal without the fringe pattern (DC only) may be projected onto an object simultaneously by a projector. Reflections of the projected signals may be captured by a dual readout sensor as two adjacent frames.

At block 804, DC component may be subtracted from the modulated signal frame (containing AC+DC) to obtain an enhanced signal (removing noise). The enhanced signal may be used to generate a wrapped phase map using Fast Fourier Transform (FFT) or similar analysis technique at block 806.

At block 808, an unwrapped phase map may be generated using phase unwrapping. The phase information in the unwrapped phase map may be converted to coordinates at block 810 and used to generate a three-dimensional reconstruction. The obtained three-dimensional features (i.e., depth information) of the object may be used for tracking purposes, for example, eye tracking, face tracking, or speed tracking.

At block 812 of FIG. 8B, two fringe patterns phase-shifted by 180 degrees may be projected onto an object simultaneously (or consecutively) by a projector. Reflections of the projected signals may be captured by a dual readout sensor as two adjacent frames.

At block 814, the phase-shifted signals may be added to extract DC component and obtain an enhanced signal (removing noise). The enhanced signal may be used to generate a wrapped phase map using Fast Fourier Transform (FFT) or similar analysis technique at block 816.

At block 818, an unwrapped phase map may be generated using phase unwrapping. The phase information in the unwrapped phase map may be converted to coordinates at block 820 and used to generate a three-dimensional reconstruction. The obtained three-dimensional features (i.e., depth information) of the object may be used for tracking purposes, for example, eye tracking, face tracking, or speed tracking.

According to examples, a method of making an object sensing system with dual readout sensor is described herein. A system of making the object sensing system is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A three-dimensional object sensing system, comprising:
a projector to transmit light onto an object;
a dual readout sensor to capture a reflection of the light from the object;
a synchronizer communicatively coupled to the projector and the dual readout sensor to coordinate transmission and capture of the light; and
a processor communicatively coupled to the projector, the sensor, and the synchronizer, the processor to:
instruct the projector to transmit the light simultaneously with and without a structured pattern;
receive two readouts corresponding to the transmitted light with and without the structured pattern;
derive an enhanced signal from the two readouts;
generate a wrapped phase map from the enhanced signal;
generate an unwrapped phase map from the wrapped phase map; and
generate a three-dimensional reconstruction of the object from the unwrapped phase map.

2. The three-dimensional object sensing system of claim 1, wherein the processor is to derive the enhanced signal from the two readouts by subtracting a reflection of the light without the structured pattern in a first readout from a reflection of the light with the structured pattern in a second readout.

3. The three-dimensional object sensing system of claim 1, wherein the processor is to generate the unwrapped phase map from the wrapped phase map using a depth-calibrated unwrapped phase map.

4. The three-dimensional object sensing system of claim 1, wherein the processor is to generate the three-dimensional reconstruction of the object from the unwrapped phase map by converting phase information in the unwrapped phase map to three-dimensional coordinates.

5. The three-dimensional object sensing system of claim 1, wherein the processor is to generate the wrapped phase map from the enhanced signal by applying a Fourier transformation to the enhanced signal.

6. The three-dimensional object sensing system of claim 1, wherein the structured pattern is a periodic fringe pattern.

7. The three-dimensional object sensing system of claim 1, wherein
the projector comprises a side-emitting laser diode, a vertical-cavity surface-emitting laser diode, a superluminescent light-emitting diode, or a light-emitting diode (LED); and
the projector emits at least one of visible light, infrared light, or near-infrared (NIR) light.

8. The three-dimensional object sensing system of claim 1, wherein the object is an eye and the three-dimensional object sensing system is an eye tracking system.

9. A three-dimensional object sensing system, comprising:
a projector to transmit a structured pattern onto an object;
a dual readout sensor to capture a reflection of the structured pattern from the object;
a synchronizer communicatively coupled to the projector and the dual readout sensor to coordinate transmission and capture of the structured pattern; and
a processor communicatively coupled to the projector, the sensor, and the synchronizer, the processor to:
instruct the projector to transmit simultaneously two phase-shifted structured patterns;
receive two readouts corresponding to the two phase-shifted structured patterns;
derive an enhanced signal from the two readouts;
generate a wrapped phase map from the enhanced signal;
generate an unwrapped phase map from the wrapped phase map; and
generate a three-dimensional reconstruction of the object from the unwrapped phase map.

10. The three-dimensional object sensing system of claim 9, wherein the two phase-shifted structured patterns comprise a first structured pattern and a 180-degree phase-shifted second structured pattern.

11. The three-dimensional object sensing system of claim 10, wherein the processor is to derive the enhanced signal from the two readouts by adding a reflection of the first structured pattern in a first readout from a reflection of the second structured pattern in a second readout.

12. The three-dimensional object sensing system of claim 9, wherein the processor is to generate the unwrapped phase map from the wrapped phase map using a depth-calibrated unwrapped phase map.

13. The three-dimensional object sensing system of claim 9, wherein the processor is to generate the three-dimensional reconstruction of the object from the unwrapped phase map by converting phase information in the unwrapped phase map to three-dimensional coordinates.

14. The three-dimensional object sensing system of claim 9, wherein the processor is to generate the wrapped phase map from the enhanced signal by applying a Fourier transformation to the enhanced signal.

15. A method, comprising:
projecting a first light and a second light simultaneously onto an object;
capturing a reflection of the first light and a reflection of the second light from the object as two adjacent frames in a dual readout sensor;
deriving an enhanced signal from the captured reflection of the first light and the captured reflection of the second light by removing a noise component from the captured reflection of the first light;
generating a wrapped phase map from the enhanced signal;
generating an unwrapped phase map from the wrapped phase map using a depth-calibrated unwrapped phase map; and
generating a three-dimensional reconstruction of the object from the unwrapped phase map.

16. The method of claim 15, wherein the first light and the second light have a same intensity and the first light is superimposed with a periodic fringe pattern.

17. The method of claim 16, wherein deriving the enhanced signal comprises:
subtracting the captured reflection of the second light from the captured reflection of the second light.

18. The method of claim 15, wherein the first light and the second light both comprise period fringe patterns phase-shifted by 180 degrees.

19. The method of claim 18, wherein deriving the enhanced signal comprises:
adding the captured reflection of the second light and the captured reflection of the second light.

20. The method of claim 15, wherein generating the wrapped phase map comprises:
applying a Fourier transformation to the enhanced signal.
